(19) United States
(12) Patent Application Publication
(10) Pub. No.: US 2026/0369644 A1
(43) Pub. Date: Nov. 19, 2026

(54) ENHANCED ETHANOL OXIDATION REACTION (EOR) ON MULTI-METALLIC Au-Cu-Pt CATALYSTS FOR ETHANOL FUEL CELLS

(71) Applicant: Toyota Motor Engineering & Manufacturing North America, Inc., Plano, TX (US)

(72) Inventors: Honghong Lin, Ann Arbor, MI (US); Shouheng Sun, East Greenwich, RI (US); Yuliang Chen, Providence, RI (US); Siwen Wang, Livonia, MI (US); Chen Ling, Troy, MI (US); Gaohua Zhu, Ann Arbor, MI (US)

(73) Assignees: Toyota Motor Engineering & Manufacturing North America, Inc., Plano, TX (US); Toyota Jidosha Kabushiki Kaisha, Aichi-ken (JP); Brown University, Providence, RI (US)

(21) Appl. No.: 19/211,595

(22) Filed: May 19, 2025

(51) Int. Cl. H01M 8/1011; H01M 4/02; H01M 4/86; H01M 4/92; H01M 8/1004

(52) U.S. Cl. CPC H01M 8/1013; H01M 4/8657; H01M 4/921; H01M 4/926; H01M 8/1004; H01M 2004/021

(57) ABSTRACT

Disclosed is a direct ethanol fuel cell (DEFC) comprising: an anode, a cathode, and an ion exchange membrane (IEM) disposed between the anode and the cathode. The anode is configured to catalyze an ethanol oxidation reaction (EOR). The at least one catalyst layer is disposed on the ion exchange membrane (IEM) and comprises multi-metallic Au—Cu—Pt alloy catalyst nanoparticles having enhanced activity for the ethanol oxidation reaction (EOR) in DEFCs. The multi-metallic Au—Cu—Pt alloy catalyst nanoparticles a core/shell structure wherein the core is surrounded by the shell. The core comprises from about 65 to about 75 at % gold (Au), from about 8 to about 18 at % copper (Cu), and from about 13 to about 23 at % platinum (Pt), and the shell comprises from about 70 to about 80 at % gold (Au), from about 3 to about 11 at % copper (Cu), and from about 11 to about 21 at % platinum (Pt).

### TECHNICAL FIELD

The present disclosure generally relates to multi-metallic catalyst materials for ethanol oxidation reaction (EOR) and direct ethanol fuel cells (DEFCs).

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly not implicitly admitted as prior art against the present technology.

High density hydrogen storage is still a significant challenge for transportation applications. Ethanol is one of the most promising fuel candidates because it has almost eight times higher volumetric energy density than hydrogen (6.35 vs 0.8 kWh/L, respectively) and can be massively produced from biomass. Methanol is another fuel commonly used in fuel cells. The oxidation pathway of methanol is simpler and leads to complete oxidation of CO₂, but methanol is toxic, volatile and has a low energy density. By comparison, ethanol is non-toxic, has a higher boiling point and is renewable. The chemical energy of ethanol can be converted to electricity in fuel cells, also known as direct ethanol fuel cells (DEFCs), but complete oxidation is more difficult due to carbon-carbon bonds, and conversion efficiency is limited by the low activity of the state-of-the-art electrocatalysts in catalyzing the ethanol oxidation reaction (EOR, the anode reaction).

Thus, there is a desire for more efficient electrocatalyst for EOR in direct ethanol fuel cells.

### SUMMARY

This section provides a general summary of the disclosure and is not a comprehensive disclosure of its full scope or all of its features.

In some aspects, the present disclosure relates to a direct ethanol fuel cell (DEFC) comprising: an anode, a cathode, and an ion exchange membrane (IEM) disposed between the anode and the cathode; and at least one catalyst layer disposed on the ion exchange membrane (IEM). The anode is configured to catalyze an ethanol oxidation reaction (EOR). The at least one catalyst layer comprises multi-metallic Au—Cu—Pt alloy catalyst nanoparticles comprising a core/shell structure wherein the core is surrounded by the shell. The core comprises from about 65 to about 75 at % gold (Au), from about 8 to about 18 at % copper (Cu), and from about 13 to about 23 at % platinum (Pt), and the shell comprises from about 70 to about 80 at % gold (Au), from about 3 to about 11 at % copper (Cu), and from about 11 to about 21 at % platinum (Pt). In some examples, the direct ethanol fuel cell (DEFC) is configured to operate in alkaline conditions. In some examples, the ion exchange membrane is an anion exchange membrane.

The multi-metallic Au—Cu—Pt alloy catalyst nanoparticles may be configured to cleave C—C bonds. In some examples, the at least one catalyst layer is disposed on an anode-facing side of the ion exchange membrane (IEM). The multi-metallic Au—Cu—Pt alloy catalyst nanoparticles may have a total diameter from about 2 to about 20 nm. The shell of the multi-metallic Au—Cu—Pt alloy catalyst nanoparticles may have a diameter from about 0.3 to about 2 nm. The multi-metallic Au—Cu—Pt alloy catalyst nanoparticles may comprise nanostructure selected from nanorods, nanowires, nanoframes, nanoplates, nanodisks, and nanosheets. In some examples, the nanostructure may be a nanorod or a nanowire having a length from about 1 nm to about 1 μm and the shell may have a thickness from about 0.3 to about 2 nm. In other examples, the nanostructure may be a nanodisk or a nanosheet wherein the shell has a diameter of about 1 nm to about 1 μm and a thickness from about 0.3 to about 2 nm.

In some aspects, the present disclosure relates to a membrane electrode assembly (MEA) for a direct ethanol fuel cell (DEFC). The membrane electrode assembly (MEA) comprises: an anode and a cathode; an ion exchange membrane (IEM) positioned between the anode and cathode; and at least one catalyst layer disposed on an anode-facing side of the ion exchange membrane. The catalyst layer ma bey configured to catalyze an ethanol oxidation reaction (EOR). The at least one catalyst layer comprises multi-metallic Au—Cu—Pt alloy catalyst nanoparticles comprising a core/shell structure wherein the core is surrounded by the shell. The core comprises from about 65 to about 75 at % gold (Au), from about 8 to about 18 at % copper (Cu), and from about 13 to about 23 at % platinum (Pt). The shell comprises from about 70 to about 80 at % gold (Au), from about 3 to about 11 at % copper (Cu), and from about 11 to about 21 at % platinum (Pt).

In some examples, the MEA may be configured to operate under alkaline conditions. In some examples, the at least one catalyst layer is disposed on an anode-facing side of the ion exchange membrane (IEM). In some examples, the ion exchange membrane is an anion exchange membrane (AEM).

The multi-metallic Au—Cu—Pt alloy catalyst nanoparticles of the MEA may be configured to promote cleavage of carbon-carbon (C—C) bonds during an ethanol oxidation reaction (EOR). The multi-metallic Au—Cu—Pt alloy catalyst nanoparticles may have a total diameter from about 2 to about 20 nm. The shell of the multi-metallic Au—Cu—Pt alloy catalyst nanoparticles may have a diameter from about 0.3 to about 2 nm. The multi-metallic Au—Cu—Pt alloy catalyst nanoparticles may comprise nanostructures selected from nanorods, nanowires, nanoframes, nanoplates, nanodisks, and nanosheets. In some examples, the nanostructure may be a nanorod or a nanowire having a length from about 1 nm to about 1 μm and wherein the shell has a thickness from about 0.3 to about 2 nm. In other examples, the nanostructure may be a nanodisk or a nanosheet having a shell with a diameter of about 1 nm to about 1 μm and a thickness from about 0.3 to about 2 nm.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings wherein:

FIG. 1A is an illustration of a direct ethanol fuel cell (DEFC).

FIG. 1B is a cross-sectional view of the membrane electrode assembly (MEA) used in the DEFC, showing the relative positioning of the anode, cathode, ion exchange membrane (IEM), and catalyst layers.

FIG. 1C is a schematic diagram illustrating the electrochemical operation of a DEFC under alkaline conditions, including ethanol and hydroxide ion input at the anode, oxygen input at the cathode, hydroxide ion transport across the IEM, and the associated half-cell and overall redox reactions.

FIG. 2 is a schematic illustration of ethanol oxidation reaction (EOR) pathways under alkaline conditions, showing the parallel formation of intermediate and final products through both the C₂-pathway and C₁-pathway.

FIG. 3A is a schematic illustration of the atomic structure of the multi-metallic Au—Cu—Pt alloy catalyst nanoparticles of the present disclosure having a core/shell structure.

FIG. 3B is a schematic illustration of the atomic structure of the multi-metallic Au—Cu—Pt alloy catalyst nanoparticles of the present disclosure having a core/shell structure with a nanorod or nanowire nanostructure.

FIG. 3C is a schematic illustration of the atomic structure of the multi-metallic Au—Cu—Pt alloy catalyst nanoparticles of the present disclosure having a core/shell structure with a nanodisk, nano plate, or nanosheet nanostructure.

FIG. 4 is a graph illustrating the Faradaic efficiencies for C₁ and C₂ products measured during ethanol oxidation reaction (EOR) at 0.6 V versus the reversible hydrogen electrode (RHE) for various catalysts, including Au—Cu—Pt samples and etched Au—Cu—Pt samples having varying molar ratios of Au: Pt, and commercial Pt/C.

FIG. 5A is an illustration of a plot showing cyclic voltammetry (CV) curves of Sample 2, Etched Sample 2, AuPt, each having the same molar ratio of Au: Pt, and commercial Pt/C catalysts measured in 1 M KOH+1 M ethanol, demonstrating differences in mass activity as a function of applied potential.

FIG. 5B is a bar graph comparing the peak mass activities (normalized to total Au+Pt content) of Au—Cu—Pt nanoparticles with varying compositions before and after etching, highlighting the enhancement in activity due to compositional tuning and surface modification.

FIG. 6A is an illustration of a plot of cyclic voltammetry curves collected in 1 M KOH saturated with CO, showing the electrochemical response of AuPt nanoparticles and AuCuPt nanoparticles with varying compositions.

FIG. 6B is an illustration of a plot of cyclic voltammetry curves collected in 1 M KOH saturated with CO for etched AuCuPt nanoparticles with varying compositions.

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific examples within the scope of this technology. Further, certain aspects may incorporate features from a combination of figures.

### DETAILED DESCRIPTION

The present disclosure provides a multi-metallic alloy catalyst material designed to be efficient and effective for ethanol oxidation reactions (EOR) in direct ethanol fuel cells (DEFCs) fueled by ethanol. A direct ethanol fuel cell (DEFC) is a type of electrochemical device that converts the chemical energy of ethanol (C₂H₅OH) directly into electrical energy through redox reactions. DEFCs are promising for portable power generation due to ethanol's high energy density, low toxicity, and renewable availability from biomass and fermentation. The unique composition, size, and structure of the multi-metallic alloy catalyst material of the present disclosure result in substantially improved mass activity, selectivity for the carbon-carbon (C—C) bond, and superior catalytic performance for ethanol oxidation reactions in alkaline conditions in DEFCs.

The present disclosure provides a direct ethanol fuel cell (DEFC) comprising: an anode, a cathode, and an ion exchange membrane (IEM) disposed between the anode and the cathode; and at least one catalyst layer disposed on the ion exchange membrane (IEM). The anode is configured to catalyze an ethanol oxidation reaction (EOR). The at least one catalyst layer comprises multi-metallic Au—Cu—Pt alloy catalyst nanoparticles comprising a core/shell structure wherein the core is surrounded or encapsulated by the shell. The core comprises from about 65 to about 75 at % gold (Au), from about 8 to about 18 at % copper (Cu), and from about 13 to about 23 at % platinum (Pt). The shell comprises from about 70 to about 80 at % gold (Au), from about 3 to about 11 at % copper (Cu), and from about 11 to about 21 at % platinum (Pt).

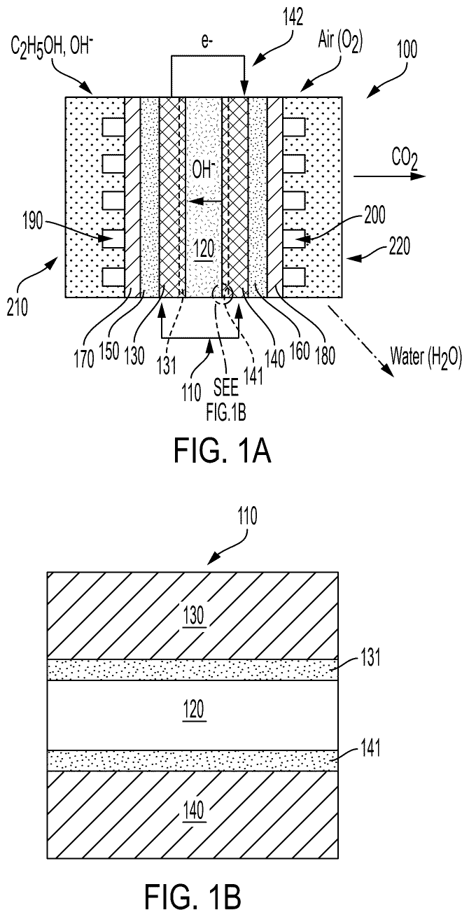

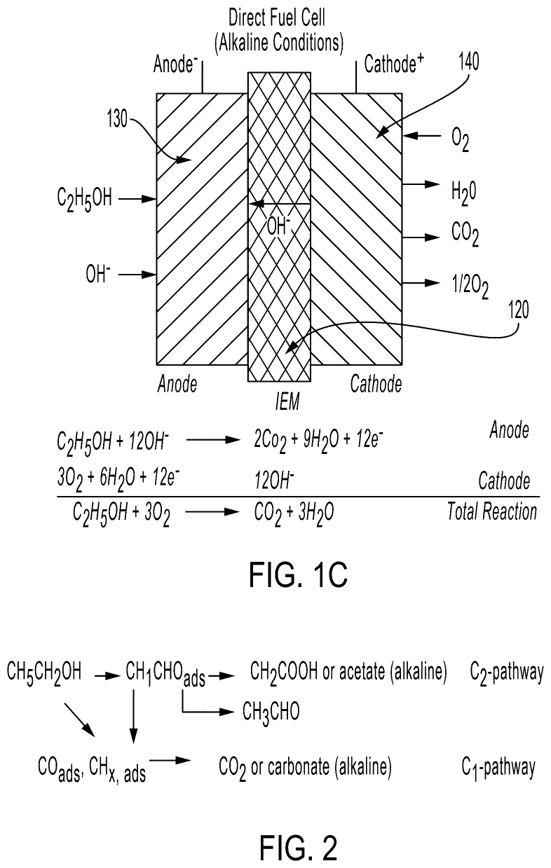

FIGS. 1A-1C illustrate the components and operation of a direct ethanol fuel cell (DEFC) 100. The DEFC 100 includes a membrane-electrode assembly (MEA) 110, which comprises an ion exchange membrane (IEM) 120, positioned between an anode 130 and a cathode 140, and an external electrical circuit 142 that electrically connects the anode 130 and the cathode 140. A first microporous layer 150 (also referred to herein as an “anodic microporous layer”) (AMPL) contacts the anode 130. An anode gas diffusion layer (AGDL) 170 contacts the first microporous layer 150 and a first flow channel 190 contacts the anode gas diffusion layer 170. A second microporous layer (also referred to herein as a “cathodic microporous layer”) (CMPL) 160 contacts the cathode 140. A cathode gas diffusion layer (CGDL) 180 contacts the second microporous layer 160 and a second flow channel 200 contacts the cathode gas diffusion layer 180. An anode bipolar plate 210 may contact the first flow channel 190 and a cathode bipolar plate 220 may contact the second flow channel 200.

The fuel is typically ethanol (C₂H₅OH), which may be stored in liquid form in a fuel tank and introduced into the anode side of the direct ethanol fuel cell (DEFC). The oxidizing gas is typically an oxygen-containing gas, such as ambient air, which is introduced into the cathode side of the fuel cell. FIG. 1A illustrates the general structure of a DEFC. Ethanol is introduced to the anode 130 side, where it undergoes electrochemical oxidation in the presence of hydroxide ions (OH) that migrate from the cathode 140 through the ion exchange membrane 120. The ethanol oxidation reaction (EOR) produces carbon dioxide (CO₂), water (H₂O), and electrons (e). The electrons flow through an external electrical circuit 142 toward the cathode 140 to generate electrical power.

At the same time, oxygen from the air flows into contact with the cathode 140, where it reacts with incoming electrons and water to generate hydroxide ions (OH⁻) in the presence of a cathode catalyst layer 141. When operated under alkaline conditions, the hydroxide ions migrate through the ion exchange membrane 120, which is an anion exchange membrane (AEM) when the DEFC is operated in alkaline conditions, from the cathode to the anode to sustain the redox reaction. In this manner, Pt-containing nanoparticles or other suitable catalysts assist in and enhance the reaction of ethanol at the anode and oxygen at the cathode.

The anode bipolar plate 210 and the cathode bipolar plate 220 can independently be formed from a metal such as titanium or stainless steel, or from a carbon-based structure such as graphite. In some embodiments, metal bipolar plates are coated with a carbon film on one or more surfaces to improve corrosion resistance and conductivity. For example, U.S. Pat. No. 10,283,785, incorporated herein by reference, teaches the use of an amorphous carbon film coating on bipolar plates.

In a direct ethanol fuel cell (DEFC), the ethanol fuel and the oxidizing gas (such as ambient air) must be delivered separately to the respective anode and cathode electrodes across the entire surface area without mixing. Accordingly, the bipolar plates are designed to be gas-tight to prevent cross-contamination between the fuel and oxidant streams. The bipolar plates also serve as current collectors, conducting electrons generated at the anode to the external circuit and/or adjoining cells in a fuel cell stack.

Additionally, the bipolar plates are configured with flow channels to distribute liquid ethanol to the anode side and oxygen-containing gas to the cathode side, manage water flow, and dissipate heat generated during operation. The plates provide mechanical support and act as backing structures to facilitate the stacking of individual fuel cells in multi-cell configurations.

FIG. 1B is a cross-sectional view of the membrane electrode assembly (MEA) 110 used in the DEFC of FIG. 1A. The MEA 110 includes an ion exchange membrane 120, which may be an anion exchange membrane (AEM), an anode catalyst layer 131 disposed on an anode-facing side of the ion exchange membrane, and a cathode catalyst layer 141 disposed on a cathode-facing side of the membrane. The anode catalyst layer 131 comprises multi-metallic Au—Cu—Pt alloy nanoparticles described herein, which are configured to catalyze the ethanol oxidation reaction (EOR).

The anode 130 is the site where ethanol (C₂H₅OH) and, depending on the operating environment, either water (H₂O) or hydroxide ions (OH⁻) are present or participate in the reaction. At the anode 130, ethanol undergoes electrochemical oxidation to produce carbon dioxide (CO₂), electrons (e), and ionic species, which may include either protons (H⁺) in acidic media or hydroxide ions (OH⁻) in alkaline media. This oxidation process initiates the flow of electrons from the anode 130 to the cathode 140 via an external circuit, thereby generating electrical energy. The ionically charged species generated at the anode 130 migrate through the ion exchange membrane 120, which may be an anion exchange membrane (AEM) in alkaline conditions or a proton exchange membrane (PEM) in acidic conditions. The ion exchange membrane 120 is selectively permeable to the corresponding charge carrier—protons or hydroxide ions—while blocking the passage of electrons.

The cathode 140 receives oxygen (O₂) from ambient air. At the cathode 140, a reduction reaction occurs in which oxygen molecules combine with the ionic species transported through the ion exchange membrane and with electrons arriving from the external circuit to form water (H₂O). The complete redox process within the DEFC is represented by the overall chemical reaction:

C₂H₅OH+3O₂→2CO₂+3H₂O.

This reaction reflects the simultaneous oxidation of ethanol at the anode and the reduction of oxygen at the cathode, culminating in the production of carbon dioxide and water as byproducts, along with a continuous flow of electrical energy.

In some examples of the present disclosure, the direct ethanol fuel cell operates under alkaline conditions. FIG. 1C is a schematic diagram illustrating the operation of a direct ethanol fuel cell (DEFC) under alkaline conditions. Referring to FIG. 1C, the ion exchange membrane 120 is an anion exchange membrane (AEM), and the electrolyte supports the transport of hydroxide ions (OH). At the anode 110, ethanol (C₂H₅OH) is oxidized in the presence of hydroxide ions to generate carbon dioxide (CO₂), water (H₂O), and electrons (e). The electrons travel through the external circuit 142, while oxygen (O₂) is supplied to the cathode 140. There, oxygen reacts with water and the incoming electrons to regenerate hydroxide ions, which are transported back through the AEM to the anode to sustain the oxidation reaction.

Half-cell reactions (alkaline):
Anode: C₂H₅OH+12OH⁻→2CO₂+9H₂O+12e⁻
Cathode: 3O₂+6H₂O+12e⁻→12OH⁻.

However, achieving high electrochemical performance in DEFCs presents certain challenges, particularly in relation to the ethanol oxidation reaction (EOR). One of the primary challenges in EOR is the cleavage of the carbon-carbon (C—C) bond in ethanol (CH₃CH₂OH), which is required for complete oxidation to carbon dioxide (CO₂). Unlike methanol, which contains only a single carbon atom and requires activation of only C—H and C—O bonds, ethanol and other higher alcohols require cleavage of both C—C and C—O bonds, reactions that are kinetically hindered under the low operating temperatures typically employed in DEFCs (60-90 °C).

Without being bound by any particular theory, it is believed that ethanol oxidation under alkaline conditions proceeds via two competing mechanistic pathways, as illustrated schematically in FIG. 2: the C₂-pathway and the C₁-pathway. In the C₂-pathway, ethanol is oxidized to acetaldehyde (CH₃CHO) and subsequently to acetic acid or acetate (CH₃COOH) without cleavage of the C—C bond, resulting in incomplete oxidation and reduced electron yield. In the C₁-pathway, cleavage of the C—C bond leads to the formation of adsorbed carbonaceous (ads) intermediates (e.g., CO_ads, CHx_ads), which are further oxidized to CO₂ or carbonate species, thus enabling complete oxidation and maximizing the energy output of the fuel cell.

Prior to the present disclosure, trimetallic gold-copper-platinum (Au—Cu—Pt) nanoparticles had been explored in the context of methanol oxidation reactions (MOR) but had not been employed for catalyzing ethanol oxidation reactions (EOR) in DEFCs. Catalysts developed for MOR typically promote C—H and O—H bond activation but generally lack the ability to efficiently cleave C—C bonds. As a result, such catalysts often underperform when applied to ethanol and other higher alcohols, which demand more complex bond-breaking processes.

The present disclosure provides a multi-metallic Au—Cu—Pt nanoparticle catalyst system designed to address these challenges. The multi-metallic alloy catalyst material of the present disclosure comprises trimetallic Au—Cu—Pt alloy nanoparticles having a core/shell structure wherein the core is surrounded by a shell. In some examples, the core comprises from about 65 to about 75 atomic % gold (Au), from about 8 to about 18 atomic % copper (Cu), and from about 13 to about 23 atomic % platinum (Pt), while the shell comprises from about 70 to about 80 atomic % gold (Au), from about 3 to about 11 atomic % copper (Cu), and from about 11 to about 21 atomic % platinum (Pt).

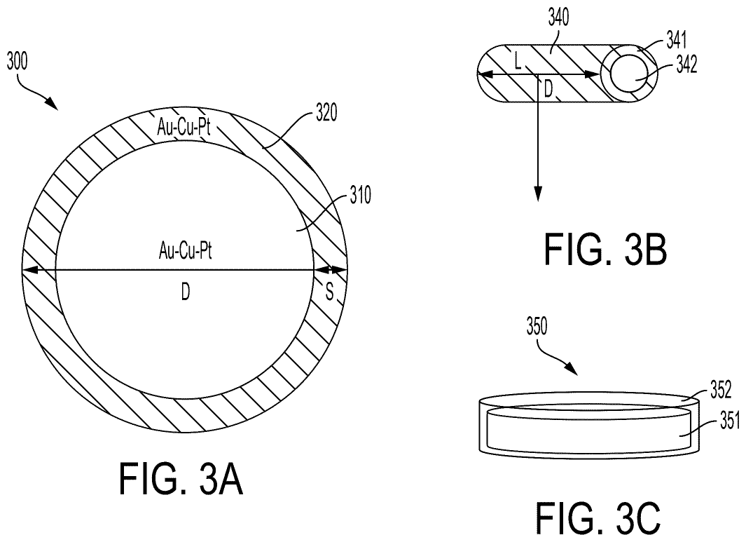

As illustrated in FIG. 3A, the multi-metallic Au—Cu—Pt alloy catalyst nanoparticles 300 may have a core/shell structure wherein the core 310 comprises Au—Cu—Pt and is surrounded by an Au—Cu—Pt shell 320. The multi-metallic Au—Cu—Pt alloy catalyst nanoparticles 300 of the present disclosure have a particle diameter D from about 2 to 20 nm. The Au—Cu—Pt shell portion of the core/shell structure may have a thickness S from about 0.3 to about 2 nm.

The size and shape of the catalytic metal particles can be optimized to maximize the total surface area of the catalyst and reaction sites available to participate in the reactions per volume of catalyst used. In general, the size affects the surface atom utilization of the catalysts. The smaller the size, the larger the surface atom percentage. The shape of the catalysts also affects the catalyst's performance.

The multi-metallic Au—Cu—Pt alloy catalyst nanoparticles 300 of the present disclosure may comprise various nanostructures classified as zero-dimensional (OD), one-dimensional (1D), or two-dimensional (2D). Examples of zero-dimensional (OD) nanostructures, include but are not limited to, spherical (i.e., round) and spheroidal (i.e., elongated). Examples of one-dimensional (1D) nanostructures, include but are not limited to, nanorods (i.e., short cylindrical structures), nanowires (i.e., thin fibers), and the like. Examples of two-dimensional (2D) nanostructures, include but are not limited to, nanoplates (i.e., flat-plate-like), nanodisks (i.e., disk-shaped), nanosheets (i.e., thin layers), and the like. The multi-metallic Au—Cu—Pt alloy catalyst nanoparticles may also comprise nanoframes (i.e., hollow skeletal structures) and other nanostructures.

FIG. 3B illustrates nanorods 340, as an example of a nanostructure of the multi-metallic Au—Cu—Pt alloy catalyst nanoparticles 300 of the present disclosure, having a rod-shaped core 342 comprising Au—Cu—Pt, a diameter D between 1-20 nm, length L from about 1 nm to about 1 μm, and being surrounded or encapsulated by the Au—Cu—Pt alloy shell 341 having a thickness from about 0.3 and about 2 nm.

FIG. 3C illustrates a nanodisk 350, another example of the nanostructures of multi-metallic Au—Cu—Pt alloy catalyst nanoparticles of the present disclosure having a disk-shaped core 351, a diameter D from about 1 nm to about 1 μm, thickness T from about 0.3 and about 2 nm, surrounded or encapsulated by the Au—Cu—Pt alloy shell 352 having a thickness T from about 0.3 and about 2 nm. The examples shown here are OD nanoparticles, but similar composition can be applied to other nanostructures to improve catalytic performance. Examples: J. Am. Chem. Soc. 2023, 145, 34, 19076-19085. In some examples, the particles of a catalytic metal may have a specific surface area of at least 10 m²/g, or 20 m²/g, or 30 m²/g, or 40 m²/g, or 50 m²/g, or 60 m²/g, or 70 m²/g, or 80 m²/g, or 90 m²/g, or 100 m²/g.

Additionally, the multi-metallic Au—Cu—Pt alloy catalyst nanoparticles of the present disclosure are designed to catalyze the ethanol oxidation reaction (EOR) in direct ethanol fuel cells (DEFCs) operating under alkaline conditions. Furthermore, as described in Example 3, Faradaic efficiency data demonstrate increased selectivity toward C₁ products, confirming that the disclosed catalysts enable more complete oxidation of ethanol. The catalyst system of the present disclosure may also be applicable for the oxidation of other higher alcohols, such as propanol and butanol, where efficient C—C bond cleavage is likewise essential for maximizing energy conversion efficiency.

In certain embodiments, the Au—Cu—Pt alloy nanoparticles disclosed herein exhibit superior activity in the ethanol oxidation reaction (EOR) compared to monometallic and bimetallic analogues. In some cases, surface modification or etching of the catalyst structure may further enhance electrochemical activity by increasing the availability of active sites and facilitating intermediate removal. The ability to promote complete oxidation through the C₁-pathway is believed to result in higher energy output. Without being limited by any particular mechanism, it is believed that the specific core/shell structure and compositional characteristics of the Au—Cu—Pt alloy nanoparticles disclosed herein facilitate not only ethanol activation but also efficient cleavage of the C—C bond, thereby promoting the C₁-pathway over the C₂-pathway, and contributing to improved EOR activity.

The ion exchange membrane may comprise specialized polymer materials selected based on whether the DEFC operates in acidic or alkaline conditions based on ion conductivity, chemical stability, mechanical strength, and ethanol tolerance. In some examples of the present disclosure the ion exchange membrane is an anion exchange membrane (AEM) for direct ethanol fuel cells (DEFCs) operating under alkaline conditions. The AEM may comprise solid state electrolytes which provide selective OH⁻conductivity, serve as separators between the anode and cathode, and allow for compact fuel cell designs. Suitable materials for the solid-state electrolytes include but are not limited to MORGANE®-ADP membranes from Solvay, or polymers of similar kind, are cross-linked fluorinated polymers containing quaternary ammonium. Other AEM polymer examples are polyvinylidene fluoride (PVDF, —[CH₂CF₂]ₙ—), poly(tetrafluoroethene-co-hexafluoro propylene) (FEP, —[CF₂CF₂]ₙ[CF(CF₃) CF₂]ₘ—) films, polysiloxane containing quaternary ammonium groups, aminated poly(oxyethylene) methacrylates, quaternized polyethersulfone cardo, quaternized poly(phthalazinon ether sulfone ketone), quaternized polyvinyl alcohol. In some examples, the AEM may comprise liquid alkaline electrolytes such as potassium hydroxide (KOH) or sodium hydroxide (NaOH). Other options for the AEM may include gel or polymer alkaline electrolytes such as polyvinyl alcohol and potassium hydroxide (PVA-KOH) gel electrolytes.

The present disclosure also provides an anode for a direct ethanol fuel cell wherein the anode comprises at least one catalyst layer at the interface and in contact with the ion exchange membrane (IEM). The catalyst layer contacting the IEM at the anode side comprises Au—Cu—Pt alloy catalyst nanoparticles having a core/shell structure. The core comprises from about 65 to about 75 atomic % gold (Au), from about 8 to about 18 atomic % copper (Cu), and from about 13 to about 23 atomic % platinum (Pt). The shell comprises from about 70 to about 80 atomic % gold (Au), from about 3 to about 11 atomic % copper (Cu), and from about 11 to about 21 atomic % platinum (Pt).

The Au—Cu—Pt alloy catalyst of the present disclosure is specifically designed for application at the anode of a direct ethanol fuel cell (DEFC). The catalyst is formulated to facilitate the ethanol oxidation reaction (EOR) under alkaline conditions, such as in an electrolyte containing potassium hydroxide (KOH) and ethanol. Unlike methanol oxidation reaction (MOR) catalysts, which are primarily optimized for the activation and oxidation of single-carbon molecules and do not require cleavage of carbon-carbon bonds, the catalyst disclosed herein is engineered to promote the more complex EOR pathway that involves the cleavage of the C—C bond in ethanol. This bond-breaking step is essential for achieving complete oxidation to carbon dioxide (CO₂) and maximizing the electron yield. The alkaline operating environment not only enhances the reaction kinetics but also supports the use of non-noble metal promoters and stabilizes the catalyst structure, enabling improved activity, durability, and resistance to intermediate poisoning as compared to MOR catalysts.

The present disclosure is also directed to a membrane electrode assembly (MEA) for a direct ethanol fuel cell (DEFC), said MEA comprising: an anode and a cathode; an ion exchange membrane (IEM) positioned between the anode and cathode; and at least one catalyst layer disposed on an anode-facing side of the ion exchange membrane, the catalyst layer being configured to catalyze an ethanol oxidation. The at least one catalyst layer comprises multi-metallic Au—Cu—Pt alloy catalyst having a core/shell structure. The core comprises from about 65 to about 75 atomic % gold (Au), from about 8 to about 18 atomic % copper (Cu), and from about 13 to about 23 atomic % platinum (Pt). The shell comprises from about 70 to about 80 atomic % gold (Au), from about 3 to about 11 atomic % copper (Cu), and from about 11 to about 21 atomic % platinum (Pt). The membrane electrode assembly (MEA) may be configured for operation under alkaline conditions, and the ion exchange membrane may be an anion exchange membrane (AEM). The multi-metallic Au—Cu—Pt alloy catalyst nanoparticles are configured to promote cleavage of carbon-carbon (C—C) bonds during the ethanol oxidation reaction (EOR).

The multi-metallic catalyst nanoparticles have a core/shell structure wherein the core is surrounded by an Au—Cu—Pt shell comprising from about 70 to about 80 atomic % gold (Au), from about 3 to about 11 atomic % copper (Cu), and from about 11 to about 21 atomic % platinum (Pt). The shell of the multi-metallic catalyst nanoparticles may have a thickness from about 0.3 to about 2 nm. The core is an Au—Cu—Pt core comprising from about 65 to about 75 atomic % gold (Au), from about 8 to about 18 atomic % copper (Cu), and from about 13 to about 23 atomic % platinum (Pt). The core may have a diameter of about 1 to about 20 nm. The multi-metallic Au—Cu—Pt alloy catalyst nanoparticles may have a total diameter of about 2 to about 20 nm. In some examples, the multi-metallic alloy catalyst nanoparticles comprise nanostructures are selected from nanorods, nanowires, nanoframes, nanoplates, nanodisks, and nanosheets. In some examples.

The multi-metallic Au—Cu—Pt alloy catalyst of the present disclosure can be applied to anodes of direct ethanol fuels cells (DEFCs) for improved EOR activity in alkaline conditions. Direct fuel cells employing the multi-metallic Au—Cu—Pt alloy catalyst of the present disclosure can be useful as a safe and renewable energy source for portable power devices such as smartphones, laptops, and remote communication equipment, and for small electric vehicles (EVs). The multi-metallic catalyst materials of the present disclosure can also be used for oxidation of higher alcohols such as propanol, butanol, etc., due to its ability to facilitate C—C bond cleavage and applied for use in direct alcohol fuel cells (DAFCs) and direct higher alcohol fuel cells (DHAFCs).

### Examples

Various aspects of the present disclosure are further illustrated with respect to the following examples. It is to be understood that these examples are provided to illustrate specific examples of the present disclosure and should not be construed as limiting the scope of the present disclosure in or to any particular aspect.

### Materials

Materials used include borane morpholine complex-oleylamine, oleylamine (70%), Cu(acac)₂, Pt(acac)₂ (Sigma Aldrich), HAuCl₄ (Strem Chemicals), 10% Nafion 212, and Ketjen 300J (Fuel Cell Store). All materials were used as received without further purification.

### Synthesis

### Example S1. Synthesis of Au—Cu—Pt Nanoparticles (NPs)

For the synthesis of Au—Cu—Pt NPs, 0.1 mmol HAuCl4, 0.1 mmol Cu(acac)₂, and Pt(acac)₂ (0.05, 0.02, 0.01 mmol for different Pt %) were mixed in a 50 ml flask with 10 ml of oleylamine (70%). This mixture was pre-heated at 85 °C under Ar atmosphere for 30 mins, followed by quick injection of borane morpholine complex-oleylamine solution (200 mg in 3 ml). The temperature was then raised to 300 °C with a ramping rate of 15 °C/mins and kept for 30 mins. After the mixture returned to room temperature, isopropanol was added to precipitate the NPs. The NPs were separated by centrifugation and washed by isopropanol/hexane (5:1) three times. Au—Cu—Pt NPs were dispersed in hexane for further use. Table 1 shows the composition of the samples.

TABLE 1
Atomic ratio of elements (%)

| Sample | Au | Cu | Pt |
|---|---|---|---|
| Sample 1 | 42 | 41 | 17 |
| Sample 2 | 53 | 36 | 11 |
| Sample 3 | 64 | 30 | 6 |
| Etched Sample 1 | 60 | 14 | 26 |
| Etched Sample 2 | 69 | 13 | 18 |
| Etched Sample 3 | 79 | 14 | 7 |

### Example S2. Catalyst Preparation

25 mg of Au—Cu—Pt NPs were deposited onto 60 mg Ketjen 300J carbon to obtain the catalyst with Pt loading of ~20 wt % for electrochemical experiment. The catalyst ink was prepared by dispersing a certain amount of carbon-supported catalyst into a mixture solution of isopropanol/water (4:1, 1 ml in total) with 10% Nafion 212 solution added. 10 μl of ink were drop-casted onto a glass carbon rotating electrode with a diameter of 5 mm to create a uniform film with Pt loading of 4 μg.

### Example 1. EOR Performance Evaluation of Au—Cu—Pt-Based Catalysts

To evaluate the electrocatalytic activity of the synthesized Au—Cu—Pt-based catalysts toward the ethanol oxidation reaction (EOR), a series of samples were tested in an alkaline electrolyte composed of 0.1 M KOH and 1.0 M ethanol (EtOH). The peak mass activities (MA) were measured during cyclic voltammetry experiments. The MA was normalized both to the mass of Pt alone and to the combined mass of Pt and Au in the catalysts. The performance metrics are summarized in Table 2.

TABLE 2

| | | Peak MA | | Peak MA |
|---|---|---|---|---|
| | Peak MA | (A/mg | Peak MA | (A/mg |
| Sample | (A/mg Pt) | Pt + Au) | (A/mg Pt) | Pt + Au) |
| Sample 1 | 74.89 | 21.94 | 59.51 | 17.20 |
| Sample 2 | 166.80 | 27.65 | 104.80 | 17.43 |
| Sample 3 | 212.50 | 22.38 | 166.13 | 17.34 |
| Etched Sample 1 | 99.99 | 31.98 | 71.37 | 22.82 |
| Etched Sample 2 | 187.98 | 34.43 | 116.05 | 21.25 |
| Etched Sample 3 | 236.58 | 23.96 | 166.18 | 16.82 |

Based on the results shown in Table 2, it can be seen that the Au-rich samples demonstrated the highest EOR activity in 0.1 M KOH+0.1M EtOH based on the peak mass activity. Specifically, Etched Sample 3 (~ 79% Au) exhibited the highest peak mass activity (236.58 A/mg Pt) and a higher C₁ selectivity, followed by Sample 3 (212.50 A/mg Pt) when normalized to total mass of noble metals (PT and Au). The performance of all Au—Cu—Pt samples improved. The results suggest that Au incorporation plays a significant role in tuning EOR activity in alkaline media and that the removal of Cu by etching enhances Pt exposure and/or electrochemically active surface area.

### Example 2. Faradaic Efficiency and C₁ Product Selectivity During Ethanol Oxidation Reaction (EOR) in 0.1 M KOH+1 M Ethanol

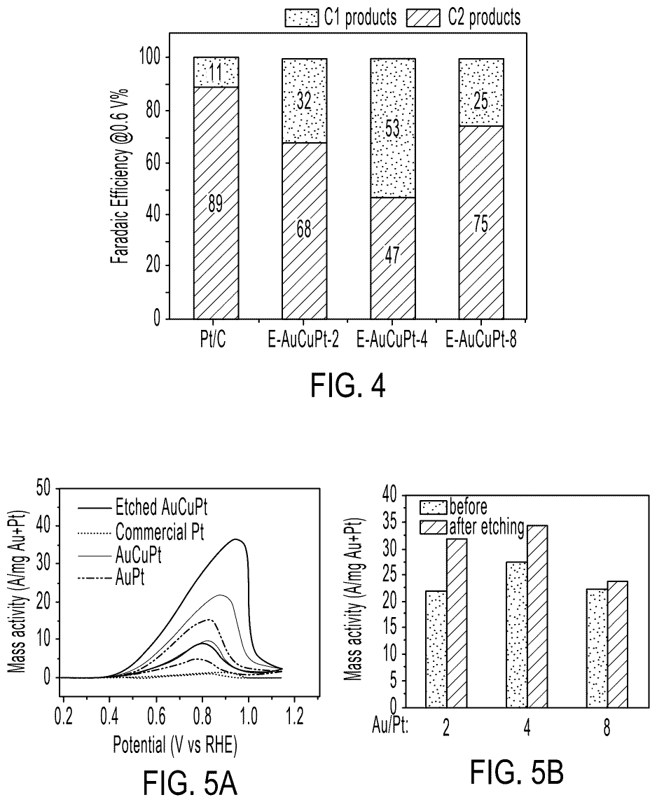

Samples 1, 2, and 3, Etched Samples 1, 2, and 3, and commercial Pt/C were further tested to evaluate their ability to promote carbon-carbon (C—C) bond cleavage during ethanol oxidation by measuring Faradaic efficiencies for C₁ and C₂ products at 0.6 V vs. RHE. The Faradaic efficiencies for C₁ and C₂ products were determined by quantifying the liquid and gaseous products generated during EOR using gas chromatography (GC) and high-performance liquid chromatography (HPLC). C₁ products primarily include CO₂, while C₂ products include acetaldehyde and acetic acid. Product quantification was cross-referenced with calibration standards to ensure accuracy. The Faradaic efficiency was calculated based on the number of electrons transferred for each product relative to the total charge passed during the reaction. The results are provided in FIG. 4. The data show that the Pt/C catalyst yields predominantly C₂ products (~89%), indicative of incomplete ethanol oxidation and limited C—C bond cleavage. By contrast, the Au—Cu—Pt alloy catalysts display an enhanced proportion of C₁ products, particularly E—Au—Cu—Pt-4, which achieves approximately 53% C₁ product selectivity, signifying improved C—C bond cleavage efficiency. These results confirm the superior activity of the disclosed Au—Cu—Pt alloy catalysts for promoting complete ethanol oxidation in direct ethanol fuel cells (DEFCs).

### Example. 3 Effect of Etching and Composition of EOR Activity

To investigate the effect of catalyst composition and post-synthesis etching on the ethanol oxidation reaction (EOR) performance, Etched Sample 2, Sample 2, commercial Pt/C, and AuPt(synthesized in the same manner as Au—Cu—Pt in Example S1, except without addition of the Cu precursor) were compared under identical conditions. The catalysts were evaluated in 0.1 M KOH+1 M ethanol, and mass activity was normalized to the total noble metal content (Au+Pt).

As shown in FIG. 5A, Etched Sample 2 exhibited the highest peak mass activity among all tested samples, followed by Sample 2, AuPt, and commercial Pt/C. This trend, Etched-Sample 2>Sample 2>AuPt>Pt, clearly demonstrates the synergistic enhancement achieved by integrating Au, Cu, and Pt, and further optimizing the surface through etching. Notably, without being bound by a particular theory, the presence of Cu and the subsequent selective removal of surface Cu via etching appears to modify the electronic and geometric structure of the catalyst, contributing to higher catalytic activity.

The enhancement effect of etching is further supported by the data in FIG. 5B, where a comparison of mass activities before and after etching is shown for Samples 1-3. Each of the etched samples showed a substantial increase in activity, with Etched Sample 2 showing the most significant improvement. These findings underscore the role of both composition and surface treatment in designing high-performance EOR catalysts.

Taken together, these results show that the incorporation of all three elements (Au, Cu, and Pt), in combination with post-synthesis etching, yields a catalyst with superior ethanol oxidation activity when normalized to total noble metal content. This supports the use of trimetallic alloy compositions and controlled surface modification strategies for improved electrocatalyst design.

### Example 4. CO Oxidation Behavior Before and After Etching

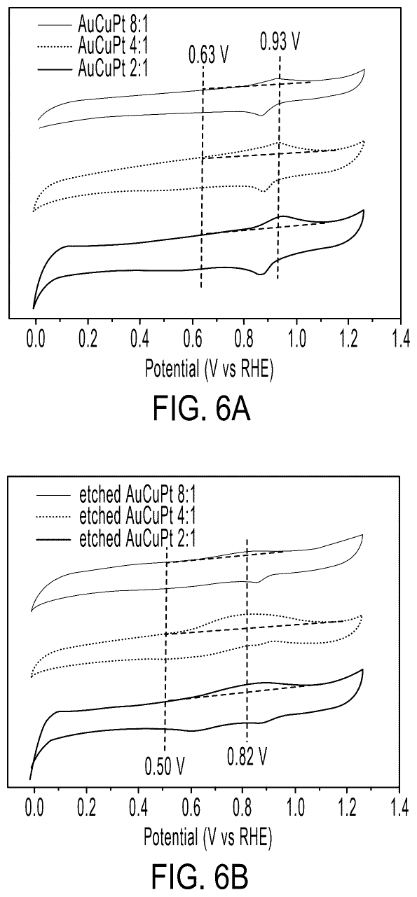

To further understand the impact of surface modification on electrocatalytic behavior, the CO oxidation properties of Au—Cu—Pt nanoparticles were analyzed before and after etching. FIGS. 6A and 6B present cyclic voltammetry curves comparing CO oxidation peaks of Samples 1, 2, and 3 (corresponding to Au—Cu—Pt with increasing Au content) and their respective etched forms.

As shown in FIG. 6A, the unetched Au—Cu—Pt samples exhibit CO oxidation peaks centered around 0.63 V and 0.93 V vs. RHE, with slight variations depending on the Au: Pt ratio. After etching (FIG. 6B), the CO oxidation peaks shift negatively to approximately 0.50 V and 0.82 V vs. RHE. This shift to lower potentials indicates that CO is more readily oxidized on the etched catalysts, which implies improved CO tolerance.

The observed negative shift in CO oxidation potential is attributed to the formation of a core/shell structure during the etching process, wherein surface Cu is selectively removed, exposing a Pt-rich shell over a more Au-rich or alloyed core. This restructuring is believed to optimize the surface electronic environment and adsorption properties, enhancing the catalyst's ability to oxidize and remove adsorbed CO intermediates more efficiently.

Effective CO removal is crucial in ethanol oxidation and other alcohol fuel cell reactions, as the accumulation of CO on active sites can inhibit catalytic activity. Therefore, the enhanced CO oxidation characteristics of the etched Au—Cu—Pt catalysts suggest that etching not only improves ethanol oxidation performance (as demonstrated in Example 3) but also promotes faster reaction kinetics by reducing CO poisoning.

These findings support the role of post-synthesis etching as a critical step in tailoring surface chemistry for high-performance, CO-tolerant electrocatalysts.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple examples having stated features is not intended to exclude other examples having additional features, or other examples incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an example can or may comprise certain elements or features does not exclude other examples of the present technology that do not contain those elements or features.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an example or particular system is included in at least one example or aspect. The appearances of the phrase “in one aspect” (or variations thereof) are not necessarily referring to the same aspect or example. It should be also understood that the various method steps discussed herein do not have to be carried out in the same order as depicted, and not each method step is required in each aspect or example.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations should not be regarded as a departure from the disclosure, and all such modifications are intended to be included within the scope of the disclosure.

What is claimed is:

1. A direct ethanol fuel cell (DEFC) comprising:
an anode, a cathode, and an ion exchange membrane (IEM) disposed between the anode and the cathode; and
at least one catalyst layer disposed on the ion exchange membrane (IEM),
wherein the anode is configured to catalyze an ethanol oxidation reaction (EOR),
the at least one catalyst layer comprises multi-metallic Au—Cu—Pt alloy catalyst nanoparticles comprising a core/shell structure wherein the core is surrounded by the shell,
wherein the core comprises from about 65 to about 75 at % gold (Au), from about 8 to about 18 at % copper (Cu), and from about 13 to about 23 at % platinum (Pt), and
wherein the shell comprises from about 70 to about 80 at % gold (Au), from about 3 to about 11 at % copper (Cu), and from about 11 to about 21 at % platinum (Pt).

2. The direct ethanol fuel cell (DEFC) according to claim 1, wherein the fuel cell is configured to operate in alkaline conditions.

3. The direct ethanol fuel cell (DEFC) according to claim 1, wherein the ion exchange membrane is an anion exchange membrane.

4. The direct ethanol fuel cell (DEFC) according to claim 1, wherein the multi-metallic Au—Cu—Pt alloy catalyst nanoparticles are configured to cleave C—C bonds.

5. The direct ethanol fuel cell (DEFC) according to claim 1, wherein the at least one catalyst layer is disposed on an anode-facing side of the ion exchange membrane (IEM).

6. The direct ethanol fuel cell (DEFC) according to claim 1, wherein the multi-metallic Au—Cu—Pt alloy catalyst nanoparticles have a total diameter from about 2 to about 20 nm.

7. The direct ethanol fuel cell (DEFC) according to claim 1, wherein the shell of the multi-metallic Au—Cu—Pt alloy catalyst nanoparticles has a diameter from about 0.3 to about 2 nm.

8. The direct ethanol fuel cell (DEFC) according to claim 1, wherein the multi-metallic Au—Cu—Pt alloy catalyst nanoparticles comprise nanostructure selected from nanorods, nanowires, nanoframes, nanoplates, nanodisks, and nanosheets.

9. The direct ethanol fuel cell (DEFC) according to claim 8, wherein the nanostructure is a nanorod or a nanowire having a length from about 1 nm to about 1 μm and wherein the shell has a thickness from about 0.3 to about 2 nm.

10. The direct ethanol fuel cell (DEFC) according to claim 8, wherein the nanostructure is a nanodisk or a nanosheet and the shell has a diameter of about 1 nm to about 1 μm and a thickness from about 0.3 to about 2 nm.

11. A membrane electrode assembly (MEA) for a direct ethanol fuel cell (DEFC), said MEA comprising:
an anode and a cathode;
an ion exchange membrane (IEM) positioned between the anode and cathode; and
at least one catalyst layer disposed on an anode-facing side of the ion exchange membrane, the catalyst layer being configured to catalyze an ethanol oxidation reaction (EOR), and
wherein the at least one catalyst layer comprises multi-metallic Au—Cu—Pt alloy catalyst nanoparticles comprising a core/shell structure wherein the core is surrounded by the shell,
wherein the core comprises from about 65 to about 75 at % gold (Au), from about 8 to about 18 at % copper (Cu), and from about 13 to about 23 at % platinum (Pt), and
wherein the shell comprises from about 70 to about 80 at % gold (Au), from about 3 to about 11 at % copper (Cu), and from about 11 to about 21 at % platinum (Pt).

12. The membrane electrode assembly (MEA) according to claim 11, wherein the MEA is configured to operate under alkaline conditions.

13. The membrane electrode assembly (MEA) according to claim 11, wherein the ion exchange membrane is an anion exchange membrane (AEM).

14. The membrane electrode assembly (MEA) according to claim 11, wherein the multi-metallic Au—Cu—Pt alloy catalyst nanoparticles are configured to promote cleavage of carbon-carbon (C—C) bonds during an ethanol oxidation reaction (EOR).

15. The membrane electrode assembly (MEA) according to claim 11, wherein the at least one catalyst layer is disposed on an anode-facing side of the ion exchange membrane (IEM).

16. The membrane electrode assembly (MEA) according to claim 11, wherein the multi-metallic Au—Cu—Pt alloy catalyst nanoparticles have a total diameter from about 2 to about 20 nm.

17. The membrane electrode assembly (MEA) according to claim 11, wherein the shell of the multi-metallic Au—Cu—Pt alloy catalyst nanoparticles has a diameter from about 0.3 to about 2 nm.

18. The membrane electrode assembly (MEA) according to claim 11, wherein the multi-metallic Au—Cu—Pt alloy catalyst nanoparticles comprise nanostructures selected from nanorods, nanowires, nanoframes, nanoplates, nanodisks, and nanosheets.

19. The membrane electrode assembly (MEA) according to claim 18, wherein the nanostructure is a nanorod or a nanowire having a length from about 1 nm to about 1 μm and wherein the shell has a thickness from about 0.3 to about 2 nm.

20. The membrane electrode assembly (MEA) according to claim 18, wherein the nanostructure is a nanodisk or a nanosheet and the shell has a diameter of about 1 nm to about 1 μm and a thickness from about 0.3 to about 2 nm.
